(19) United States
(12) Patent Application Publication
(10) Pub. No.: US 2002/0005331 A1
(43) Pub. Date: Jan. 17, 2002

(54) CONVEYOR APPARATUS

(76) Inventor: JACQUES DUSSAULT, NEUFCHATEL (CA)

Correspondence Address: PATENT ADMINSTRATOR, KATTEN MUCHIN ZAVIS, SUITE 1600, 525 WEST MONROE STREET, CHICAGO, IL, 60661, US

(21) Appl. No.: 09/394,413

(22) Filed: Sep. 13, 1999

Related U.S. Application Data
(63) Continuation-in-part of application No. PCT/CA98/00217, filed on Mar. 13, 1998.

(30) Foreign Application Priority Data
Mar. 13, 1997 (CA) 2,199,885

(51) Int. Cl. B65G 37/00; B65G 25/02

(52) U.S. Cl. 198/610; 198/776

(57) ABSTRACT

Disclosed herein is a device for moving elements from a receiving location to delivery location which comprises a frame, two sets of stairs mounted on rectilinear, inclined slide bearings within the frame, a drive mechanism comprising a rocker assembly connected to both sets of stairs to reciprocate the stairs upwardly and downwardly on the bearings one set of stairs moving upwardly as the other moves downwardly.

### REFERENCE TO COPENDING APPLICATIONS

The subject matter of U.S. Provisional Patent Application serial No. 60/131,142 filed Apr. 27, 1999 is incorporated herein by reference. The subject matter of U.S. patent application Ser. No. 09/302,405 filed Apr. 30, 1999 is also incorporated herein by reference. The subject matter of PCT Application serial number PCT/CA98/00217 filed Mar. 13, 1998 is also incorporated herein by reference.

### BACKGROUND OF TH INVENTION

1. Field of the Invention

This invention is concerned with apparatus for raising products or people from a receiving location to a delivery location. More particularly, it is concerned with a so-called step feeder.

2. Description of the Related Art

Step feeders are commonly used in saw mills to raise sawlogs and trees from a receiving location and deliver them, one by one, to a delivery location from where they are advanced for further processing. It will be apparent from what follows that while the present invention is well suited for this environment, it also may be used to transport many different kinds of products or even as an escalator.

U,S. Pat. No. 5,351,729 (Brisson) describes a typical step feeder which has a fixed set of “stairs” which comprise a plurality of inclined plates disposed in spaced vertical planes and extending from a receiving location, upwardly to a delivery station. Movable plates are supported between the plates of the stairs on swinging levers driven by a motor and crank arrangement to lift logs from one tread of the stairs to the next.

Another step feeder is described in U.S. Pat. No. 5,374,157 (Allard). It has two sets of movable stairs each comprising a plurality of inclined plates disposed in spaced vertical planes. A first set of stairs mounted on swinging levers driven by a motor and crank arrangement. The second set of stairs is also mounted on swinging levers. The second set of stairs is driven through meshing gear segments on them and on the levers of the first set of stairs. In this way, the two sets of stairs reciprocate between each other to pass a log from the tread of one set to the next rising tread of the other set and in the process the logs are unscrambled.

These devices are slow and cumbersome. It is therefore an object of the present invention to provide a novel device for moving products. It is another object of the present invention to provide a step feeder which is smooth and fast in operation.

### SUMMARY OF THE INVENTION

According to one aspect of this invention there is provided a device for moving products from a receiving location to delivery location which comprises a frame, two sets of stairs mounted on rectilinear, inclined slide bearings within the frame, a drive mechanism comprising a rocker assembly connected to both sets of stairs to reciprocate the stairs upwardly and downwardly on bearings one set of stairs moving upwardly as the other moves downwardly.

Preferably each set of stairs comprises a plurality of laterally spaced segments, the segments of one set being disposed between the segments of the other set. In one embodiment, the sum of the segments is an odd number and the weight of each set of stairs is substantially equal.

In another of its aspects, the present invention provides device for moving elements from a receiving location to a delivery location which comprises a frame, two sets of stairs mounted on rectilinear, inclined slide bearings within the frame, a drive mechanism comprising a motor driving a crank assembly, said crank assembly connected to a rocker assembly, said rocker assembly further comprising a central axis and two pivots spaced therefrom, each of said pivots connected to a corresponding one of said sets of stairs to reciprocate the stairs upwardly and downwardly on the bearings, one set of stairs moving upwardly as the other moves downwardly.

In still another of its aspects, the present invention provides a device for moving elements from a receiving location to a delivery location comprising two sets of stairs, one set having substantially the same weight as the other set, the sets of stairs being mounted for reciprocating movement along an inclined axis, a drive mechanism comprising a motor driving a crank assembly, said crank assembly connected to a rocker assembly, said rocker assembly further comprising a central axis and two pivots spaced therefrom, each of said pivots connected to a corresponding one of said sets of stairs to reciprocate the stairs upwardly and downwardly, one set of stairs moving upwardly as the other moves downwardly.

### BRIEF DESCRIPTION OF THE DRAWINGS

An embodiment of the invention is illustrated in the accompanying drawings in which:

FIG. 1 is a schematic side view of a step feeder according to this invention;

FIG. 2 is a side view of the invention members or stairs of the device in FIG. 1;

FIG. 3 is a plan view if the device of FIG. 1;

FIG. 4 is a side view of one of the two sets of transport members or stairs;

FIG. 5 is a side view and a plan view of the other of the sets of stairs;

FIG. 6 is a side view of the frame of the device of FIG. 1; and

FIG. 7 is an end view of a part of the device of FIG. 1.

FIG. 8 is a perspective view of the drive linkage of the feeder; and

FIG. 9 is a simplified side view of the feeder mechanism.

### DESCRIPTION OF THE PREFERRED EMBODIMENTS

The device comprises a frame 10 having longitudinal lower frame elements 12 connected by transverse frame elements 14. Tall columns 16 are connected to the lower frame at the delivery end 18 of the frame. Shorter columns 20 are connected to the receiving end 22 of the lower frame.

The upper ends of the columns 16 and 20 are joined by inclined beams 24. Frame elements 26, parallel to the beams 24 extend between the receiving and delivery ends of the frame. The sides of the frame are closed by panels 28.

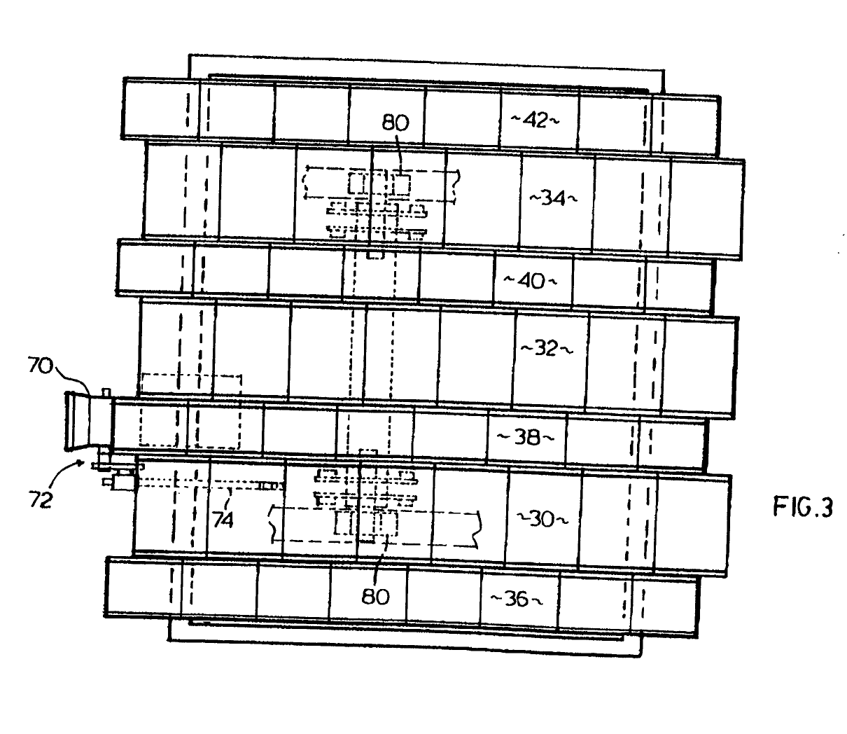

The transport members comprise two sets of stairs. The first set is in three separate segments 30,32 and 34 as seen in FIG. 3. The second comprises four segments at 36,38, 40 and 42 in FIG. 3.

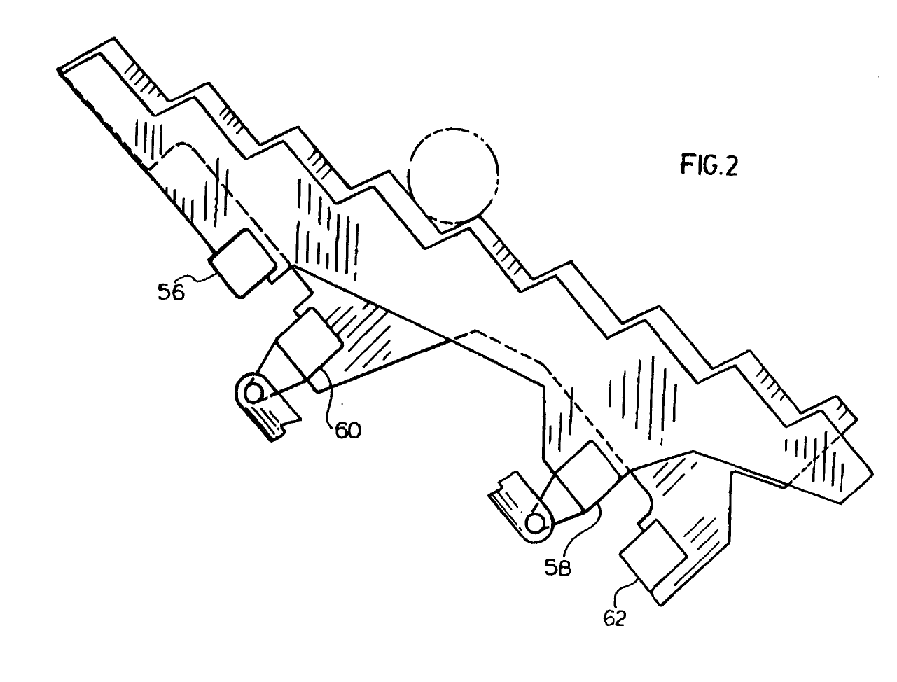

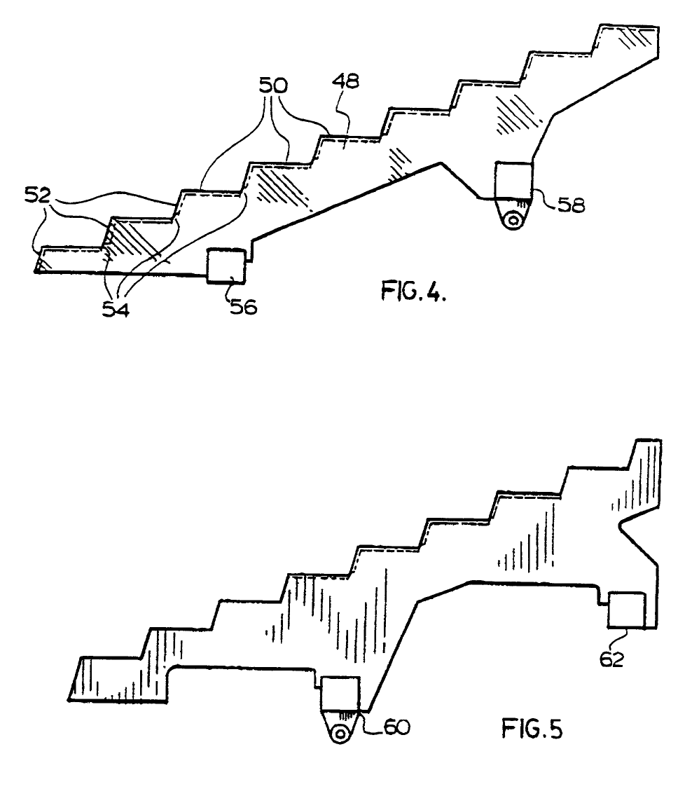

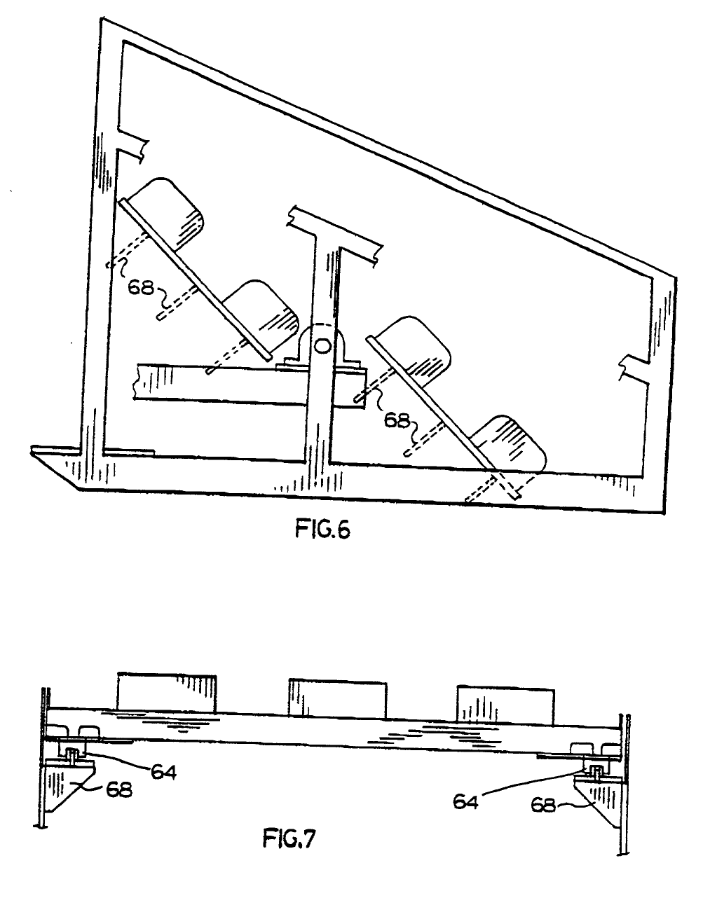

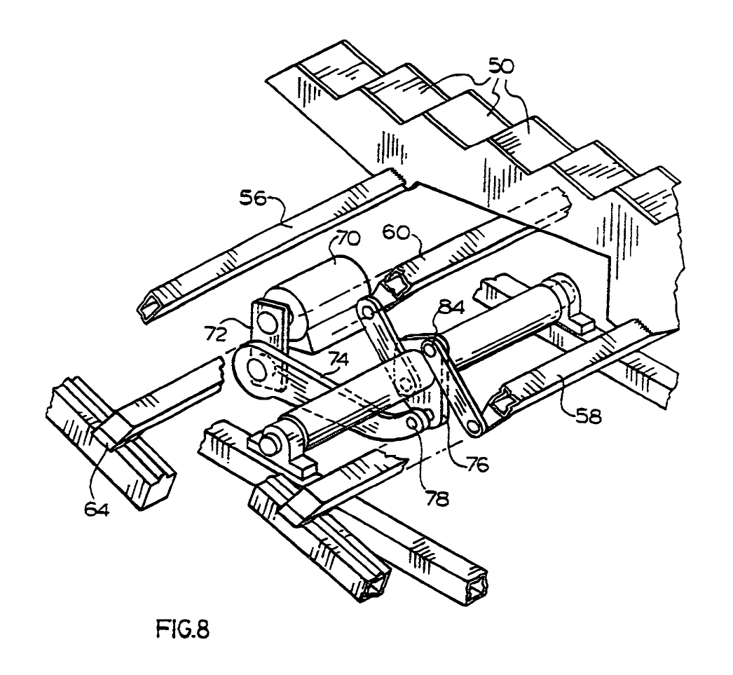

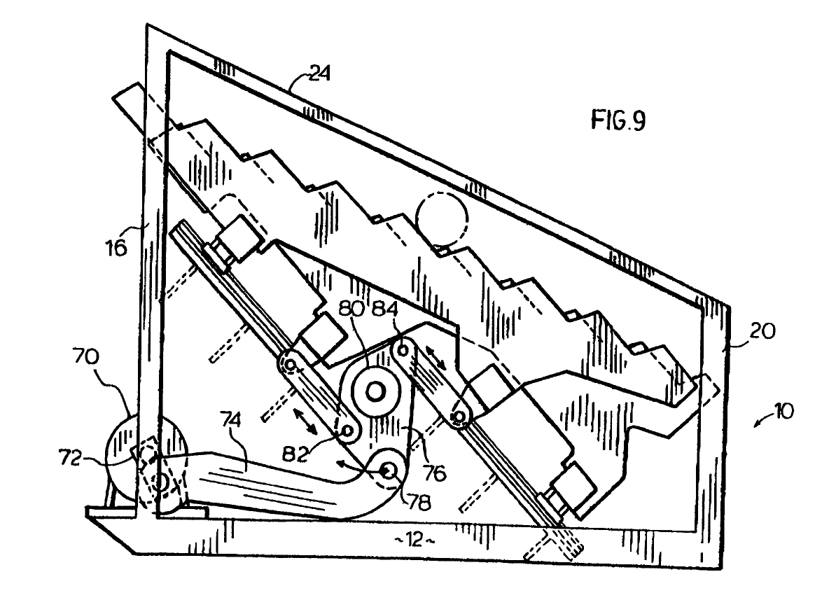

One of the segments of the first set is illustrated in FIG. 4. It comprises a pair of spaced stringers, one of which is visible at 48 joined by “tread” portions 50 and “riser” portions 52. The tread portions each have transverse slots 54 permitting drainage. The segments of the set of stairs are joined by upper and lower beams 56 and 58 connected to the stringers of the segments. The second set of stairs of which one segment is illustrated in FIG. 5 is largely similar to the first set being made up of four segments. The segments are joined by beams 60 and 62. The relative positions of the two sets of stairs are illustrated in FIG. 2.

Below the stairs there are two parallel, rectilinear bearings at 64 and 66 mounted by fillets 68 connected to the side walls 28 of the frame. The bearings are illustrated in FIG. 7. The two sets of stairs are mounted for reciprocating sliding movement on the bearings.

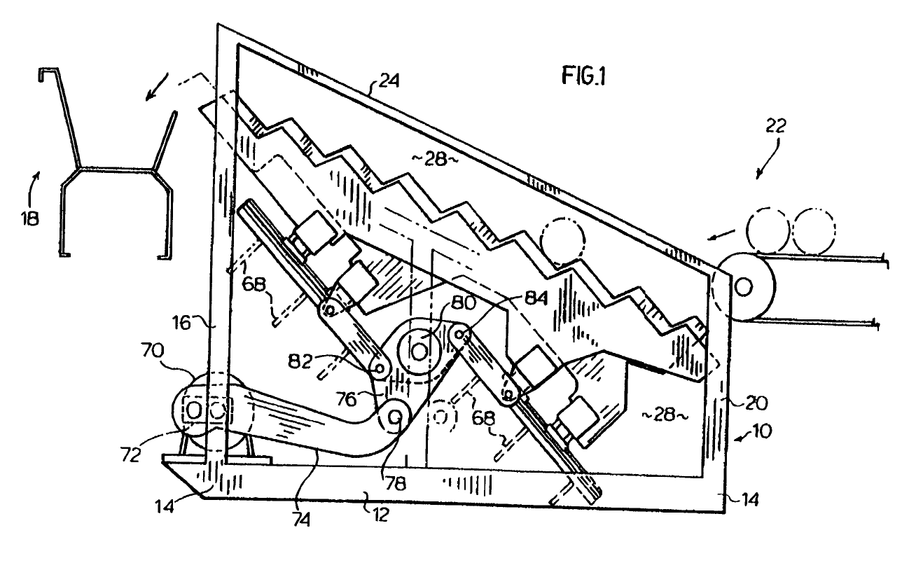

The drive comprises a motor 70 mounted in the frame and having a reducing gear and crank assembly 72. A connecting arm 74 is pivotally mounted on the crank for movement over the limits indicated in chain-lines in FIG. 1.

The end of the connecting arm is pivotally mounted to a rocker assembly 76 at pivot 78 and the rocker assembly is mounted in bearings 80 mounted in the frame. The rocker an assembly has two pivots 82 and 84, equidistantly spaced from its axis, by which it is connected to the sets of stairs. Thus as the rocker arm moves in one direction, it moves one set of stairs upwardly on the bearings 64 and 66 and the other set downwardly. It is important to note that at the mid point of the movements of the rocker assembly, a line connecting The pivots 82 and 84 is at right angles to the bearings 64 and 66. This optimizes the delivery of force to the sets of stairs and reduces the power requirement.

It will be appreciated that logs delivered along conveyor 90 to the lower or receiving end of the step feeder will fall to the stairs and will be lifted by a rising stair onto the adjacent tread of the other set of stairs and thereafter be carried from step to step to the delivery end 18 and onto a receiver 92.

The treads of the stairs are designed to ensure that they are effective to push the logs to the next step but also to permit logs on the lowermost steps to roll back onto the next following step so that the logs become unscrambled i.e. are carried one to a step and delivered to the receiver one at a time. Since a device such as that of the invention when used in a saw mill must accommodate logs of a range of diameters the treads are designed so that if two of the smallest sized logs are on a single step, the upper one must fall to the next lower step. This clearly is the case with larger logs.

The risers are made to be only a little longer than the maximum diameter of the logs with which the step feeder is to be used so that the spacing between the logs is minimized and more can be carried on the feeder.

For smooth, rapid movement, it is desirable that the device be balanced. The drive and the linear bearings substantially contribute to this end because the acceleration is smoothly sinusoidal. To improve balance further, an odd number of stair segments is used. The segments 30, 32 and 34 are each wider and heavier than the segments 36,38,40 and 42. However, the combined width of segments 36, 38, 40 and 42 is equal to the combined widths of the segments 30, 32 and 34 and their combined weight is equal to the combined weight of segments 30, 32 and 34.

While it is most desirable to match the weight of one set of stairs with the other, there may be examples where differences in the respective weights of the sets of stairs can be tolerated, depending on the characteristic of the actual components used.

Additionally, the lower steps of the stair segments are made stronger and heavier than the others to withstand the impacts of the logs falling from conveyor 90 and those as unscrambling of the logs occurs. This need not be done on the higher parts of the stairs and hence they can be less expensive.

It has been found in testing that the step feed can operate twice as quickly as known step feeders i.e. can deliver twice as many logs in a given time. It is also reliable in unscrambling the logs for delivery one at a time to the receiver 92.

It is to be appreciated that the specific embodiment illustrated herein is for use in a saw mill or like environment and for use with lumber or timber products. However, clearly the invention has application to the handling of a wide variety of products and in a situation when handling products of fixed size, it can be simplified and made specific to that size of product. It is also apparent that an appropriately modified embodiment can be used as an escalator for use by people and that such an arrangement would represent a much simplified and more power-efficient device than the conventional ‘conveyor-belt’ escalator.

1. A device for moving elements from a receiving location to delivery location which comprises a frame, two sets of stairs mounted on rectilinear, inclined slide bearings within the frame, a drive mechanism comprising a rocker assembly connected to both sets of stairs to reciprocate the stairs upwardly and downwardly on the bearings one set of stairs moving upwardly as the other moves downwardly.

2. A device as claimed in claim 1 wherein each set of stairs comprises a plurality of spaced segments, the segments of one set being disposed between the segments of the other set.

3. A device as defined in claim 2 wherein the segments of each set of stairs are laterally spaced.

4. A device as claimed in claim 3 wherein the sum of the segments is an odd number.

5. A device as claimed in claim 4 wherein the weight of each set of stairs is substantially equal.

6. A device for moving elements from a receiving location to a delivery location which comprises a frame, two sets of stairs mounted on rectilinear, inclined slide bearings within the frame, a drive mechanism comprising a motor driving a crank assembly, said crank assembly connected to a rocker assembly, said rocker assembly further comprising a central axis and two pivots spaced therefrom, each of said pivots connected to a corresponding one of said sets of stairs to reciprocate the stairs upwardly and downwardly on the bearings, one set of stairs moving upwardly as the other moves downwardly.

7. A device as defined in claim 6 wherein said pivots are equidistant from said central axis.

8. A device as defined in claim 7 wherein said pivots are collinear with said central axis.

9. A device as defined in claim 6 wherein each set of stairs includes a pair of linkages, each joining one of said pivots with said set of stairs, said rocker assembly being located between said linkages.

10. A device as defined in claim 9 wherein one of said linkages is under tension and the other of said linkages is under compression.

11. A device as defined in clam 10 wherein said rocker assembly has one position wherein a line through said pivots is at right angles to said bearings.

12. A device as claimed in claim 5 wherein each set of stairs comprises a plurality of laterally spaced segments, the segments of one set being disposed between the segments of the other set.

13. A device as claimed in claim 12 wherein the sum of the segments is an odd number.

14. A device as claimed in claim 13 wherein the weight of each set of stairs is substantially equal.

15. A device as defined in claim 5 wherein said sets of stairs travel along substantially parallel paths and said rocker assembly is movable about a horizontal axis, which is substantially perpendicular to the said paths.

16. A device for moving elements from a receiving location to a delivery location comprising two sets of stairs, one set having substantially the same weight as the other set, the sets of stairs being mounted for reciprocating movement along an inclined axis, a drive mechanism comprising a motor driving a crank assembly, said crank assembly connected to a rocker assembly, said rocker assembly further comprising a central axis and two pivots spaced therefrom, each of said pivots connected to a corresponding one of said sets of stairs to reciprocate the stairs upwardly and downwardly, one set of stairs moving upwardly as the other moves downwardly.

17. A device as defied in claim 16 wherein said pivots are connected in opposing directions to a corresponding one of said sets of stairs.

18. A device as defined in claim 16 wherein said pivots are equidistant from said central axis.

19. A device as defined in claim 18 wherein said pivots are collinear with said central axis.

20. A device as defined in claim 16 wherein each set of stairs includes a pair of linkages, each joining one of said pivots with said set of stairs, said rocker assembly being located between said linkages.

21. A device as defined in claim 20 wherein one of said linkages is under tension and the other of said linkages is under compression.

22. A device as defined in claim 16 wherein said sets of stairs are mounted on rectilinear inclined slide bearings.

23. A device as defined in claim 22 wherein said rocker assembly has one position wherein a line through said pivots is at right angles to said bearings.

24. A device as claimed in claim 16 wherein each set of stairs comprises a plurality of laterally spaced segments, the segments of one set being disposed between the segments of the other set.

25. A device as claimed in claim 24 wherein the sum of the segments is an odd number.

26. A device as defined in claim 16, wherein said sets of stairs travel along substantially parallel paths and said rocker assembly is movable about a horizontal axis, which is substantially perpendicular to the said paths.
